(19) United States
(12) Patent Application Publication
(10) Pub. No.: US 2016/0025620 A1
(43) Pub. Date: Jan. 28, 2016

(54) Optical Compositional Analysis of Mixtures

(71) Applicant: Olympus Corporation, Tokyo (JP)

(72) Inventor: Steven Lansel, E. Palo Alto, CA (US)

(21) Appl. No.: 14/338,291

(22) Filed: Jul. 22, 2014

(51) Int. Cl. G01N 21/25

(52) U.S. Cl. CPC G01N 21/255; G01N 2201/12

(57) ABSTRACT

Systems for calculating regression coefficients for estimating amounts of components in a mixture of components may comprise: a unit for supplying input optical measurements of a reference mixture, a unit for supplying learning optical measurements of the mixture, a unit for calculating component amounts from the learning measurements, a unit for obtaining the input measurements and the component amounts and calculating learned regression coefficients over the input measurements and the component amounts, and a unit for storing the coefficients, wherein the learning measurements are characterized by one or more of (1) having more bands than those of the input measurements and (2) being narrowband measurements. Furthermore, systems for estimating component amounts of a mixture may comprise a unit for obtaining the input optical measurements and the learned regression coefficients, applying a regression function using the learned regression coefficients to the input optical measurements, and estimating component amounts of the mixture.

### FIELD OF THE INVENTION

Embodiments of the present disclosure relate generally to apparatus and methods for analysis of mixtures of materials by one or more of optical absorbance, scattering and reflectance.

### BACKGROUND

A mixture is a collection of physical matter that contains different component materials. The component materials in the mixture may be combined in such a way that it is difficult to separate or distinguish each of the component materials. If it is possible to optically distinguish the component materials of the mixture, it may be desirable to optically measure the mixture without separation.

Consider a mixture of a number, m, of different component materials. It generally is desirable to determine the concentration of each of the component materials in the mixture, although it may not be practical or desirable to separate the mixture in such a way that permits measurement of the components directly. The amount of component materials can be described in various ways such as mass, weight, or volume of the total component material in the mixture or the mass concentration, molar concentration, number concentration, or volume concentration. For simplicity, the term component amount will refer to any such descriptions of a component material in a mixture.

For optical measurements, the mixture is illuminated and an optical sensor is arranged to measure the light reflected by, scattered by, and/or transmitted through the mixture. A spectrum will refer to a function of wavelength such as the object's reflectance, absorption, or transmittance. Without loss of generality, consider the arrangement where the optical sensor measures the light transmitted through the mixture. The amount of light, i(λ), that falls on an optical sensor for a wavelength λ is given by

i(λ)=t(λ)l(λ) (1)

where l(λ) is the amount of light that would fall on the sensor if the mixture is not present and t(λ) is the mixture's optical transmittance. The mixture's absorption is given by l−t(λ).

Optical sensors can be configured to measure multiple different spectral bands, sometimes simply referred to as bands. Let the number of color bands be n. Optical measurements are outputs from the optical sensor. Let yⱼ be the optical measurement from the sensor's color band j, where 1≦j≦n, which can be modeled, ignoring measurement noise, as

yⱼ=∫i(λ)sⱼ(λ)dλ (2)

where sⱼ(λ) is the spectral sensitivity of the sensor's color band j.

Most optical sensors directly measure light according to Eq. (2). However, it is common for optical equipment, particularly imaging equipment, to perform certain calculations on the optical measurements prior to storing the data in memory. For example, a transformation to a standard color space is commonly carried out on measurements prior to storage in memory. Also, tone mapping, such as a gamma transformation, is often performed to generate an image for common image display devices. Such further calculations performed on the optical measurements or the inverses of the calculations will be referred to herein as color transformations. The output of such color transformations will also be referred to herein as optical measurements.

By combining Equations (1) and (2),

yⱼ=∫t(λ)pⱼ(λ)dλ (3)

where pⱼ(λ)=l(λ) sⱼ(λ) is called a measurement function and combines the effects of the illumination and sensor's spectral sensitivities. If a measurement function, pⱼ(λ), is non-zero over a large range of wavelengths, it is said to be broadband. If a measurement function, pⱼ(λ), is nearly zero except over a small range of wavelengths, it is said to be narrowband. Herein the optical measurements from broadband or narrowband measurement functions will be referred to as broadband measurements or narrowband measurements, respectively.

The optical transmittance can generally be modeled using Beer-Lambert's law to give:

t(λ)=e^{-Σ}ₖ^{d}ₖ^{a}ₖ^{(λ)} (4)

where k is the number of the component material, 1≦k≦m, aₖ(λ) is the spectral absorption of material k, and dₖ is the component amount of material k. By combining Equations (3) and (4), yⱼ may be expressed as follows:

yⱼ=∫e^{-Σ}^{ₖ}^{d}^{ₖ}^{a}^{ₖ}^{(λ)}pⱼ(λ)dλ (5)

which provides for component amounts, dₖ, to be estimated from the optical measurements, yⱼ, assuming knowledge of the measurement functions, pⱼ(λ), and absorptions, aₖ(λ).

Current approaches for estimating component amounts often require the mixture's transmittance to be known at a number of individual wavelengths. Consider the particular case where each measurement is perfectly narrowband, meaning pⱼ(λ) is zero everywhere except at a single wavelength. Specifically for all 1≦j≦n

pⱼ(λ)=αⱼδ(λ−λⱼ) (6)

where αⱼ and λⱼ are constants and δ(λ) is a Dirac delta function that satisfies the following equation for all functions f(λ):

∫f(λ)δ(λ)dλ=f(λ) (7)

In this case, the measurements are given by

yⱼ=αⱼe^{-Σ}ₖ^{d}ₖ^{a}ₖ^{(λ)}ⱼ (8)

Taking the natural logarithm of Eq. 8 gives

log yⱼ=log αⱼ−Σₖdₖaₖ(λⱼ) (9)

Using Eq. (9), one can form a system of linear equations to constrain the component amounts, dₖ. This system of equations can be solved to estimate the component amounts. One such method is the Moore-Penrose pseudo inverse solution that minimizes the squared error.

For the particular case defined in Eq. (6) where optical measurements are perfectly narrowband, the component amounts can theoretically be calculated accurately and efficiently. FIGS. 12 and 13 show the result of applying the method described in Eq. (9) to each pixel of the image in FIG. 11.

However, measurements can never be so ideally narrowband. Such narrowband measurements necessitate using certain optical measurement designs that are restrictive and typically require a specialized optical measurement system for the specific mixture being analyzed. Narrowband light may be selected for measurement by using specific light filters, or narrowband illumination sources, for example. Narrowband measurements are also susceptible to measurement noise because the amount of light measured is generally much less than for broadband measurements. Measurement noise will subsequently lower the accuracy of the calculated component amounts.

Although the above approach can estimate the component amounts for the special case of ideal narrowband measurements, the approach fails when applied to broadband measurements. To illustrate the shortcoming for broadband measurements, consider the following extension of the ideal narrowband method.

Let δ_{w}(λ) be given by the following equation, where w is a positive constant in units of nanometers

$${δ}_{w} ( λ ) = \{ \begin{matrix}\frac{1}{w} , & \vert w \vert < w / 2 \\ 0 , & \vert w \vert > w / 2\end{matrix} \qquad ( 10 )$$

Note that the following equation holds for all functions f(λ):

∫f(λ)δ_{w}(λ)dλ=1/w∫_{-w/2}^{w/2}f(λ)dλ (11)

For small values of w, the two functions δ(λ) and δ_{w}(λ) are approximately equal. An experiment is performed for different values of w. For the experiment, two measurement functions of the form δ_{w}(λ−505) and δ_{w}(λ−655) are used. The integrals are approximated by a discrete summation using wavelength sampling with 5 nm bins. The experiment is performed on measurements of tissue samples stained with hematoxylin and eosin dyes and mounted on microscope slides. (FIG. 11 shows an image of a tissue sample prepared as a thin slice of several microns thickness of a block specimen obtained from a removed organ or a pathological specimen obtained from a needle aspiration biopsy; the tissue sample is stained with hematoxylin and eosin stains prior to observation. The cell nuclei pick up the bluish purple hematoxylin stain and cytoplasm picks up the red eosin stain. The spectral absorption of the dyes is shown in FIG. 10 and the image resulting from the measurements is shown in FIG. 11.)

In the absence of measurement noise, perfect agreement is achieved by independently processing measurements from each pixel from the slide shown in FIG. 11 using Eq. (9) with w=5, which indicates ideal narrowband filters, and with the component amounts shown in FIGS. 12 and 13. However, errors are significant when the measurement filters are not narrowband. For example, w=55, results in a mean squared error for the eosin component amount of 0.0625.

Another approach is to spectrally estimate desired transmittance values from a number of optical measurements and then estimate the component amounts by assuming Beer-Lambert's law, for example. This approach requires a large number of measurements and heavy computation to estimate the transmittance, and can yield results with poor accuracy.

A third approach is to accurately measure or estimate the reflectance of a mixture using optical measurements. By examining the second derivative of the reflectance, the amount of component materials in the mixture can be inferred. For example, the location of local maximums or minimums of the second derivative of the reflectance can indicate the relative amount of different component materials in soil mixtures. See “Use and Limitations of Second-Derivative Diffuse Reflectance Spectroscopy in the Visible to Near-Infrared Range to Identify and Quantify Fe Oxide Minerals in Soils” A. C. Scheinost, et al., Clays and Clay Minerals 1998 46: 528-536. This method requires accurate spectral reflectance in order to take the second derivative, which requires a large number of measurements with little measurement noise.

The prior art restricts the type and/or number of measurement functions. Either a few narrowband measurements or a large number of broadband measurements are generally required.

There is a need for systems and methods for more efficient optical compositional analysis.

### SUMMARY OF THE INVENTION

A system for calculating regression coefficients for estimating amounts of components in a mixture of components may comprise: an input optical measurement supply unit for supplying input optical measurements of a reference mixture; a learning optical measurement supply unit for supplying learning optical measurements of the reference mixture; a component amount calculation unit for calculating component amounts from the learning optical measurements; a learning unit for obtaining the input optical measurements and the component amounts and calculating learned regression coefficients over the input optical measurements and the component amounts; and a parameter storage unit for storing the learned regression coefficients, wherein the learning optical measurements are characterized by one or more of (1) having more bands than those of the input measurements and (2) being narrowband measurements.

A system for estimating component amounts from optical measurements of a mixture may comprise: a first input optical measurement supply unit for supplying input optical measurements of the mixture; a parameter storage unit for storing learned regression coefficients; and a processing unit for obtaining the input optical measurements and the learned regression coefficients, applying a regression function using the learned regression coefficients to the input optical measurements, and estimating component amounts of the mixture.

A system for calculating learned regression coefficients for estimating component amounts of a mixture may comprise: a component amount storage unit for storing component amounts; a mixture measurement unit for obtaining input optical measurements from mixtures with the component amounts; a learning unit for obtaining the component amounts and the input optical measurements, and calculating learned regression coefficients over the component amounts and the input optical measurements; and a parameter storage unit for storing the learned regression coefficients.

A system for estimating component amounts from optical measurements of a mixture may comprise: an input optical measurement supply unit for supplying second input optical measurements of the mixture; a parameter storage unit for storing learned regression coefficients, wherein the learned regression coefficients are optimally found over first input optical measurements and associated learning optical measurements, and wherein the learning optical measurements are characterized by one or more of (1) having more bands than those of the input measurements and (2) being narrowband measurements; a processing unit for obtaining second input optical measurements and the learned regression coefficients, applying a regression function using the learned regression coefficients to the second input optical measurements, and estimating learning optical measurements of the mixture; a component amount calculation unit for calculating component amounts based on the estimated learning optical measurements; and a component amount storage unit stores the component amounts.

A system for estimating component amounts of a mixture may comprise: an input optical measurement supply unit for supplying second input optical measurements of the mixture; a parameter storage unit for storing learned regression coefficients, wherein the learned regression coefficients are optimally found over first input optical measurements and associated spectra; a processing unit for obtaining the second input optical measurements and the learned regression coefficients, applying a regression function using the learned regression coefficients to the second input optical measurements, and calculating estimated spectra of the mixture; a component amount calculation unit for calculating component amounts from the estimated spectra; and a component amount storage unit for storing the component amounts.

A method of calculating learned regression coefficients for the estimation of mixture component amounts may comprise: supplying input optical measurements of a reference mixture to a learning unit; supplying learning optical measurements of the reference mixture to a calculation unit; in the calculation unit, calculating component amounts from the learning optical measurements; in the learning unit, calculating learned regression coefficients over the input optical measurements and the component amounts; and storing the learned regression coefficients in a storage unit. The learning optical measurements are characterized by one or more of (1) having more bands than those of the input measurements and (2) being narrowband measurements.

A method of estimating component amounts from optical measurements of a mixture may comprise: supplying input optical measurements of the mixture to one or more processing units; storing learned regression coefficients in a storage unit; and in the one or more processing units, applying a regression function using the learned regression coefficients to the input optical measurements, and estimating component amounts of the mixture.

A method of calculating learned regression coefficients for estimating component amounts of a mixture may comprise: storing component amounts in a component amount storage unit; in a mixture measurement unit, obtaining input optical measurements from mixtures with the component amounts; in a learning unit, calculating learned regression coefficients over the component amounts and the input optical measurements; and storing the learned regression coefficients in a parameter storage unit.

A method of estimating component amounts from optical measurements of a mixture may comprise optimally finding learned regression coefficients over first input optical measurements and associated learning optical measurements. The learning optical measurements are characterized by one or more of (1) having more bands than those of the input measurements and (2) being narrowband measurements. The method may further comprise: storing the learned regression coefficients in a parameter storage unit; supplying second input optical measurements of the mixture to an input optical measurement supply unit; in one or more processing units, applying a regression function using the learned regression coefficients to the second input optical measurements, estimating learning optical measurements of the mixture, and calculating component amounts based on the estimated learning optical measurements; and storing the component amounts in a component amount storage unit.

A method of estimating component amounts of a mixture may comprise: supplying second input optical measurements of the mixture; storing learned regression coefficients a parameter storage unit for, wherein the learned regression coefficients are optimally found over first input optical measurements and associated spectra; in one or more processing units, applying a regression function using the learned regression coefficients to the second input optical measurements, and calculating estimated spectra of the mixture; in a component amount calculation unit, calculating component amounts from the estimated spectra; and storing the component amounts in a component amount storage unit.

### BRIEF DESCRIPTION OF THE DRAWINGS

These and other aspects and features of the present disclosure will become apparent to those ordinarily skilled in the art upon review of the following description of specific embodiments in conjunction with the accompanying figures, wherein:

FIG. 1 is a schematic diagram of a learning system that derives learned regression coefficients from training data where component amounts are found using learning optical measurements, according to some embodiments;

FIG. 2 is a flow diagram of a learning method that derives learned regression coefficients from training data containing mixtures with known component amounts, according to some embodiments;

FIG. 3 is a schematic diagram of a processing system for estimating a component amount from optical measurements of a mixture, according to some embodiments;

FIG. 4 is a schematic diagram of a processing system for estimating a component amount image from an input image, according to some embodiments;

FIG. 5 is a flow diagram of a processing method for estimating a component amount from optical measurements of a mixture, according to some embodiments;

FIG. 6 is a schematic diagram of a learning system that finds learned regression coefficients from training data containing mixtures with known component amounts, according to some embodiments;

FIG. 7 is a flow diagram of a learning method that finds learned regression coefficients from training data where optical measurements are of mixtures with known component amounts, according to some embodiments;

FIG. 8 is a schematic diagram of a learning system that finds learned regression coefficients from training data to estimate learning optical measurements from input optical measurements, according to some embodiments;

FIG. 9 is a schematic diagram of a processing system for calculating component amounts from estimated learning optical measurements of a mixture, according to some embodiments;

FIG. 10 is a plot of spectral absorption of hematoxylin and eosin dyes;

FIG. 11 is a red, green, and blue image of a tissue sample stained with hematoxylin and eosin dyes and mounted on a microscope slide;

FIG. 12 is the image of FIG. 11 processed to show the amount of hematoxylin dye;

FIG. 13 is the image of FIG. 11 processed to show the amount of eosin dye; and

FIG. 14 is a block schematic diagram of a system in the exemplary form of a computer system for performing optical compositional analysis of mixtures, according to some embodiments.

### DETAILED DESCRIPTION

Embodiments of the present disclosure will now be described in detail with reference to the drawings, which are provided as illustrative examples of the disclosure so as to enable those skilled in the art to practice the disclosure. The drawings provided herein include representations of devices and device process flows which are not drawn to scale. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure. In the present specification, an embodiment showing a singular component should not be considered limiting; rather, the disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The present disclosure describes methods and apparatus for accurately and efficiently estimating any component amount in a mixture from an arbitrary set of measurement functions. Optical measurements used to calculate the component amounts are called input optical measurements. The method described herein takes advantage of finding optimal parameters, such as regression coefficients, by a learning process over a set of training data for enabling compositional analysis of a mixture.

The method for estimating component amounts from input optical measurements of a mixture for some embodiments will now be described. The input optical measurements of a mixture, yⱼ for 1≦j≦n, are to be used to estimate the desired component amount dₖ. Let the function g(yⱼ)=zⱼ be known with zⱼ being a vector of length q. The function g(yⱼ) is a generator of the regression function that will be used to estimate the component amounts from the input optical measurements. The function g(yⱼ) has to be pre-determined but may be chosen through theoretical or experimental analysis of the problem (measurement functions, absorption functions, and typical concentration values) and resultant data. Most importantly the regression function generated by g(yⱼ) must give accurate estimates for the training data. Furthermore, the function g(yⱼ) is defined appropriately for the specific mixture and optical measurements. Let z be a vector of length nq formed by concatenating each of the zⱼ vectors for 1≦j≦n. Each entry of z is called a term of the regression function. Suppose the desired component amount corresponds to component material k for 1≦k≦m. The regression function for one embodiment is given by

[symbol]

=Wₖz (12)

where [symbol] is the estimate of the component amount for component k and Wₖε [symbol] ^{l×nq} are regression coefficients for component k. When the regression coefficients are found by optimizing over a set of training data, the regression coefficients are said to be learned regression coefficients. Although the terms of the regression function for this particular embodiment each contain only one optical measurement, this need not be the case for all embodiments.

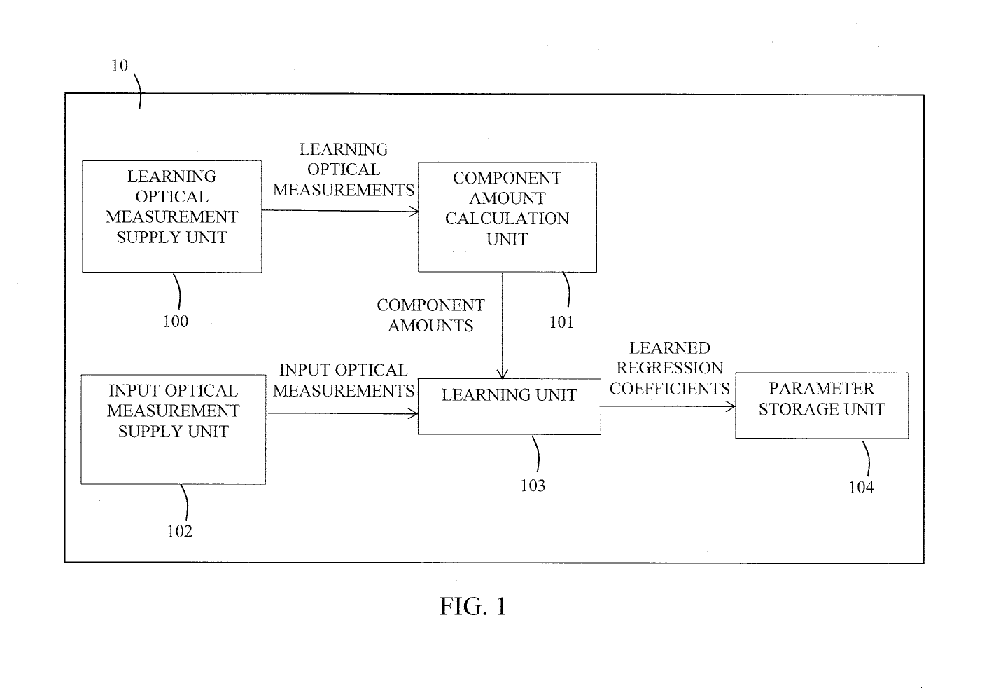

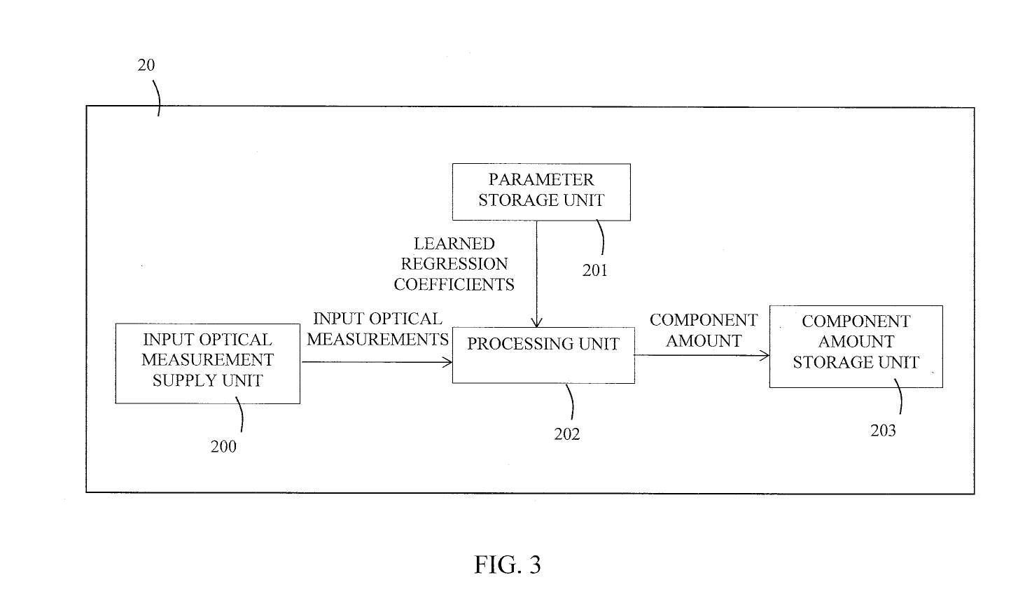

FIG. 1 is a schematic diagram showing a learning system 10 according to some embodiments that finds learned regression coefficients from training data where component amounts are found using learning optical measurements. The learning optical measurement supply unit 100 supplies learning optical measurements of reference mixtures in the training data. Learning optical measurements are optical measurements where the measurement functions, called learning measurement functions, are chosen to enable accurate estimation of a mixture's component amounts through methods generally known in the field. Examples of such learning measurement functions are functions that provide narrowband measurements or a greater number of broadband measurements than input optical measurements, which can yield component amount estimates using the methods described above, for example. The component amount calculation unit 101 calculates component amounts of mixtures from the learning optical measurements. The input optical measurement supply unit 102 supplies input optical measurements of the same mixtures for which component amounts have been calculated. Note that the input optical measurements of FIG. 1 and the input optical measurements supplied by 200 in FIG. 3 should be of a similar nature. Compare FIGS. 1 & 3. For example, similar measurement functions and color transformations (if used) should be used for both input optical measurements. The learning unit 103 calculates learned regression coefficients that are designed to estimate component amounts from input optical measurement amounts; the calculation of the learned regression coefficients may be by a least squares optimization The learned regression coefficients are stored by the parameter storage unit 104 for later use.

It may be necessary or desirable to use special optical measurement equipment to achieve the learning measurement functions of unit 100. For example, a liquid crystal tunable filter may be used to filter the light, where all light except light near a particular wavelength is electronically removed. Another example is to use equipment which images under a variety of different colored illuminations such as could be generated with various types of LEDs. Since the learning measurement functions are chosen to enable component amount estimation using standard techniques, there generally are a number of restrictions on the learning measurement functions and associated optical equipment. For example, one may use optical equipment that enables specially selected measurement functions such as narrowband measurements or a large number of optical measurements with different measurement functions. This special optical measurement equipment generally requires more cost, careful calibration, and/or more time to acquire measurements than some embodiments described herein. An advantage of some embodiments described herein is that although special optical measurement equipment may be needed for the learning process, special optical measurement equipment is generally not needed for compositional analysis of a mixture once the learning process is complete. In other words, units 102 and 200 can utilize less complex optical measurement equipment than used for unit 100. For example, according to certain embodiments, units 101 and 200 may include a microscope with standard white light specimen illumination and RGB image sensors for optical measurement acquisition. The regression coefficients derived from the learning process can be applied to an arbitrary set of measurement functions.

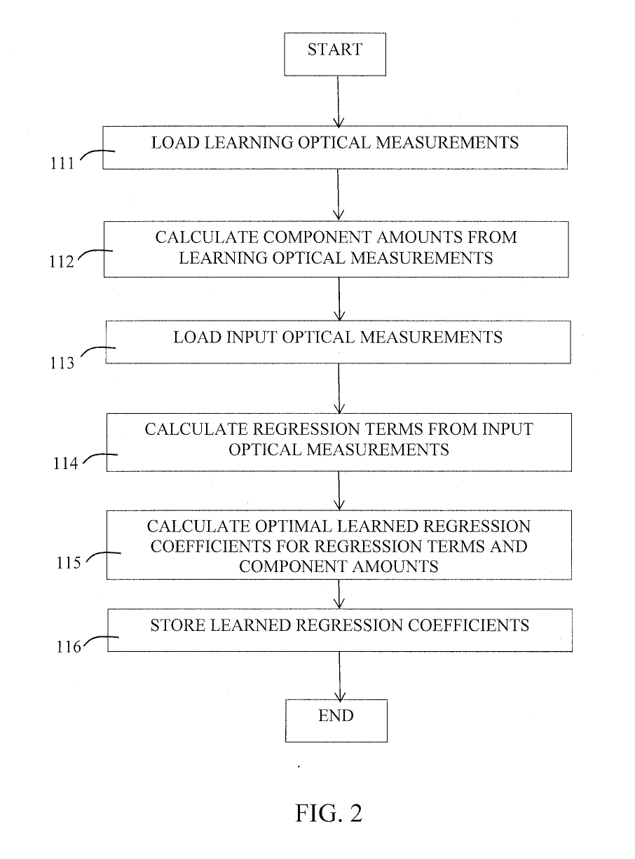

FIG. 2 is a flow diagram illustrating operation of the learning system 10 of FIG. 1 that finds learned regression coefficients from training data where component amounts are found using learning optical measurements. The training data consists of learning optical measurements of a large number, s, of mixtures. In 111, the learning optical measurements are loaded into the component amount calculation unit 101 from the learning optical measurement supply unit 100 of FIG. 1. (Note that in embodiments unit 100 could be measurement equipment to simply acquire but not store data, or unit 100 could be storage for measurements that were acquired with some special equipment, or unit 100 could both acquire and store the measurements.) Suppose the desired component amount corresponds to component material k for 1≦k≦m. Let dₖ be a length s row vector of component amounts for material k in each of the mixtures in the training data. In 112, these component amounts, dₖ, are calculated in the component amount calculation unit 101 from the learning optical measurements using methods generally known in the field or prior art, and are then sent to the learning unit 103. Let y be a length n vector where the entries are given by input optical measurements, yⱼ. Let Yε [symbol] ^{n×s} be a matrix whose columns contain vectors y for each mixture in the training data. In 113, this matrix is loaded into the learning unit 103. Let Zε [symbol] ^{nq×s} be a matrix of regression terms whose columns contain vectors z calculated as described previously using columns of Y. In 114, Z is calculated by the learning unit 103. Let the length s row vector [symbol] be the estimated component amounts for the mixtures observed in the training data given by the following equation.

[symbol]

=WₖZ (13)

Corresponding columns of Z, dₖ, and [symbol] represent the same mixture from the training data. In one embodiment, Wₖ is found by minimizing the L2 norm of the error given by |dₖ− [symbol] . The optimal learned regression coefficients are given by

Wₖ=dₖZ⁺ (14)

where Z⁺ is the Moore-Penrose pseudoinverse given by Z⁺=Z^{T}(ZZ^{T})⁻¹ assuming the inverse exists. In 115, the optimal learned regression coefficients are calculated in the learning unit 103, and in 116, the optimal learned regression coefficients are stored in the parameter storage unit 104 for later use.

FIG. 3 is a schematic diagram showing a processing system 20 for estimating a component amount from optical measurements of a mixture according to some embodiments. Input optical measurement supply unit 200 supplies input optical measurements of a mixture for analysis of component amounts. (Note that in embodiments unit 200 could be measurement equipment to simply acquire but not store data, or unit 200 could be storage for measurements that were acquired with some special equipment, or unit 200 could both acquire and store the measurements.) Parameter storage unit 201 stores learned regression coefficients. Processing unit 202 calculates the amount of a desired component from the optical measurements of a mixture. Component amount storage unit 203 stores the calculated component amount. Furthermore, note that unit 200 generally provides measurements acquired with imaging equipment, although if sufficient information about a mixture (either multispectral or component amounts) is known, it may be possible to compute the input measurements—for example, by reweighting the multispectral information, the input measurements can be approximated. An example of the latter is the method used to generate FIG. 11, which illustrates a red, green, and blue image of a microscope slide stained with hematoxylin and eosin dyes. The method involved; measuring a physical slide using 63 bands; and digitally calculating the RGB image using these 63 bands.

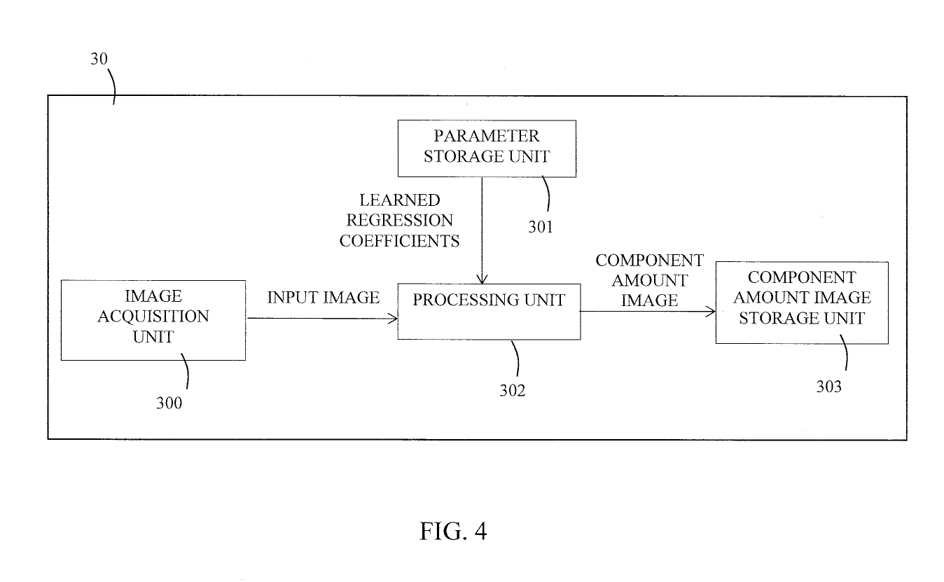

FIG. 4 is a schematic diagram showing a processing system 30 for estimating a component amount image from an input image, according to some embodiments. Image acquisition unit 300 acquires an input image for analysis of component amounts at each pixel, where each pixel of the input image contains optical measurements of a mixture. Parameter storage unit 301 stores learned regression coefficients, described in more detail below. Processing unit 302 calculates the amount of a desired component from the optical measurements of the mixture at each pixel where the processing uses the optical measurements at each pixel as the input optical measurements for the estimation of component amounts. Component amount storage unit 303 stores the calculated component amounts. The processing system 30 of FIG. 4 is equivalent to the processing system 20 of FIG. 3 applied pixel by pixel to generate an entire image.

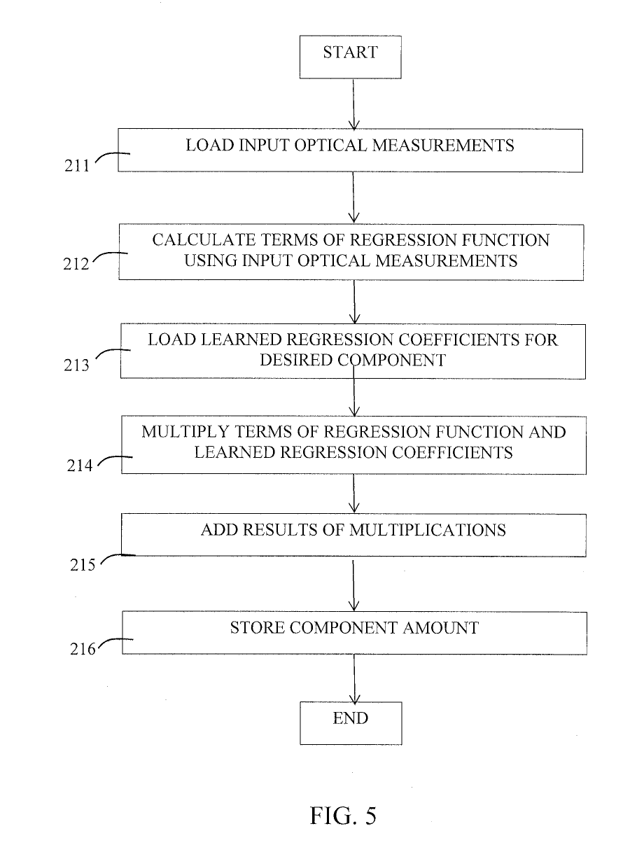

FIG. 5 is a flow diagram illustrating operation of the processing system 20 of FIG. 3 for estimating a component amount from optical measurements of a mixture at a single spatial location in a specimen. In 211, the input optical measurements, y, are loaded into the processing unit 202 from unit 200. In 212, the terms of the regression function, which are the entries of z, are calculated by the processing unit 202. In 213, the learned regression coefficients, W₁, are loaded into the processing unit 202 from unit 201. In 214, the terms of the regression function are multiplied by the regression coefficients, and in 215 the results of the multiplication are added together, all in the processing unit 202. In 216, the resultant component amounts are stored in the component amount storage unit 203.

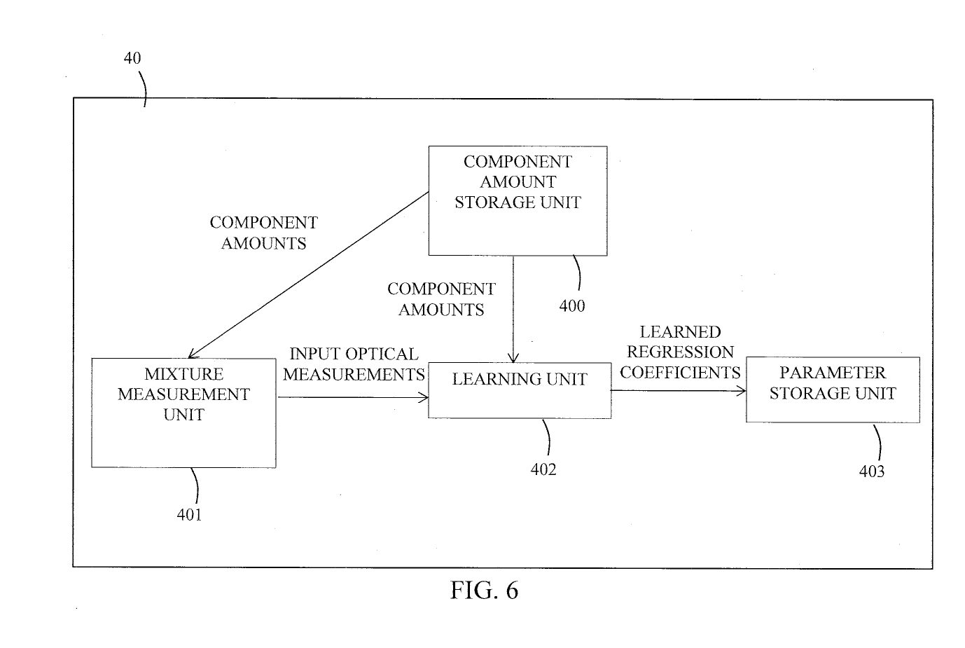

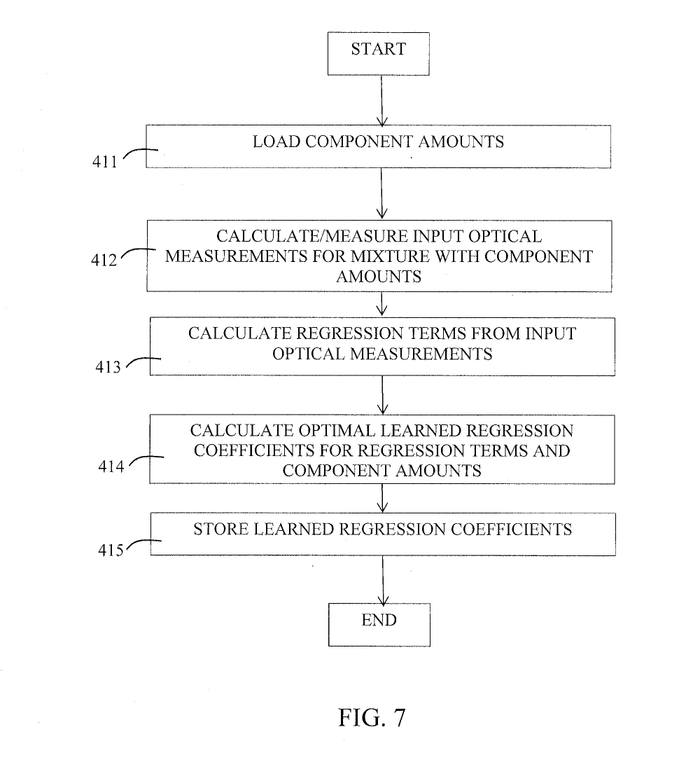

FIGS. 6 and 7 illustrate embodiments of system and method for generating input optical measurements from component amounts for input to a learning unit; this is an alternative to embodiments described above with reference to FIGS. 1-2 for which optical measurements are acquired for learning. In other words, input optical measurements can be either physically acquired or computationally generated from the component amounts. FIG. 6 is a schematic diagram showing a learning system 40 that derives learned regression coefficients from training data containing mixtures with known component amounts Note that FIGS. 1 and 6 illustrate different ways to calculate learned regression coefficients—once the learned regression coefficients are found using either method, they are applied the same way (see FIG. 3 or 4). The component amount storage unit 400 stores the component amounts for mixtures in the training data. (Note that unit 400 needs to contain component amounts from many mixtures, specifically the number is s, which are needed for learning, whereas unit 203 needs only contain the component amount for a single pixel that is being processed.) Mixture measurement unit 401 generates input optical measurements of the mixtures in the training data. These input optical measurements generated by unit 401 and the input optical measurements stored in supply unit 200 should be of a similar nature—in other words, the learned regression coefficients only work for estimating component amounts if they are used on the same type of measurements that were used for training. Compare FIGS. 3 & 6. For example, similar measurement functions and color transforms (if used) should be used for both input optical measurements—in more detail, similar measurement functions (defined previously as pⱼ(λ)) are functions that are either the same or differ only by scalar multiples or linear combinations. (Two sets of measurement functions would differ by a scalar multiple if the intensity of the illumination is adjusted on an imaging system but the same type of illumination and the same sensor are used.) In general, having a different spectral shape of the illumination or sensor's sensitivity for learning and processing would not work. Learning unit 402 calculates learned regression coefficients from the component amounts and input optical measurements. The learned regression coefficients are stored by the parameter storage unit 403 for later use.

There are multiple modes of operation for mixture measurement unit 401 in FIG. 6. One method is to make physical mixtures by combining the desired amount of each of the component materials and take optical measurements of the physical mixtures using optical measurement equipment, such as a microscope and/or camera, optionally including one or more of illumination sources (which may be narrow band or broad band—for example, discrete colors or white light) and spectral filters. Another method involves modeling the optical properties of mixtures, such as transmittance, reflectance, etc., and calculating input optical measurements using the model. For example, with knowledge of the component amounts, spectral absorptions, and measurement functions, the optical measurements can be simulated using Eq. (5).

FIG. 7 is a flow diagram illustrating operation of the learning system 40 of FIG. 6 which derives learned regression coefficients from training data containing mixtures with known component amounts. In 411, the component amounts of the mixtures are loaded into the learning unit 402. In 412, the input optical measurements for the mixtures with component amounts are calculated/measured by mixture measurement unit 401 and provided to the learning unit. In 413, the regression terms are calculated in the learning unit from input optical measurements in a similar manner to that described above with reference to the flow chart of FIG. 2. In 414, the optimal learned regression coefficients are calculated in the learning unit in a similar manner as before. In 415, the learned regression coefficients are stored in parameter storage unit 403 for later use.

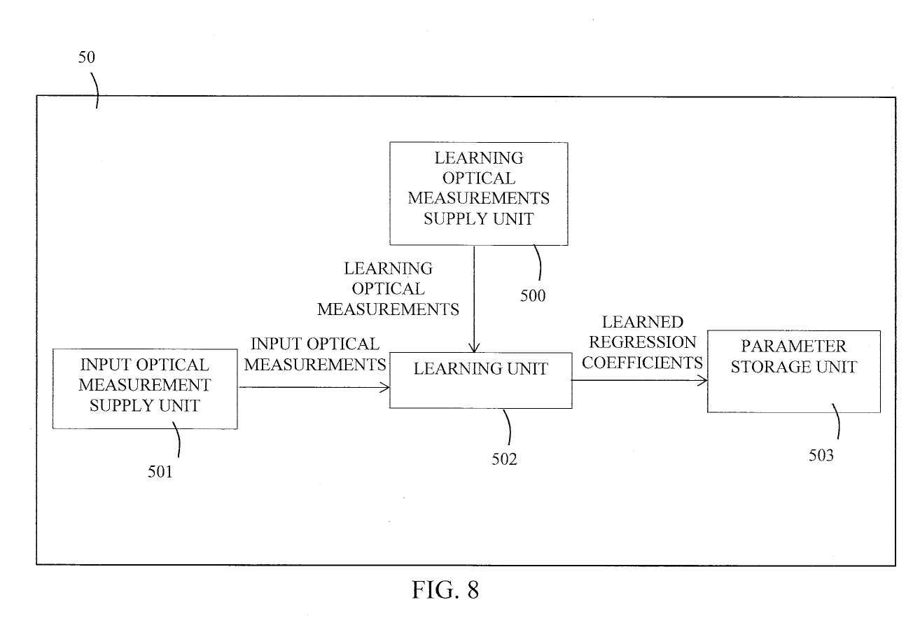

FIG. 8 is a schematic diagram showing a learning system 50 that derives learned regression coefficients from training data to estimate learning optical measurements from input optical measurements. The learning optical measurement supply unit 500 supplies learning optical measurements of mixtures in the training data. The input optical measurement supply unit 501 supplies input optical measurements of the mixtures. These input optical measurements supplied by unit 501 and the input optical measurements supplied by 600 should be of a similar nature—in other words, the learned regression coefficients only work for estimating component amounts if they are used on the same type of measurements that were used for training, as discussed above. Compare FIGS. 8 & 9. The learning unit 502 calculates learned regression coefficients. The learned regression coefficients are stored by the parameter storage unit 503 for later use. The learned regression coefficients are to estimate learning optical measurements from input optical measurements.

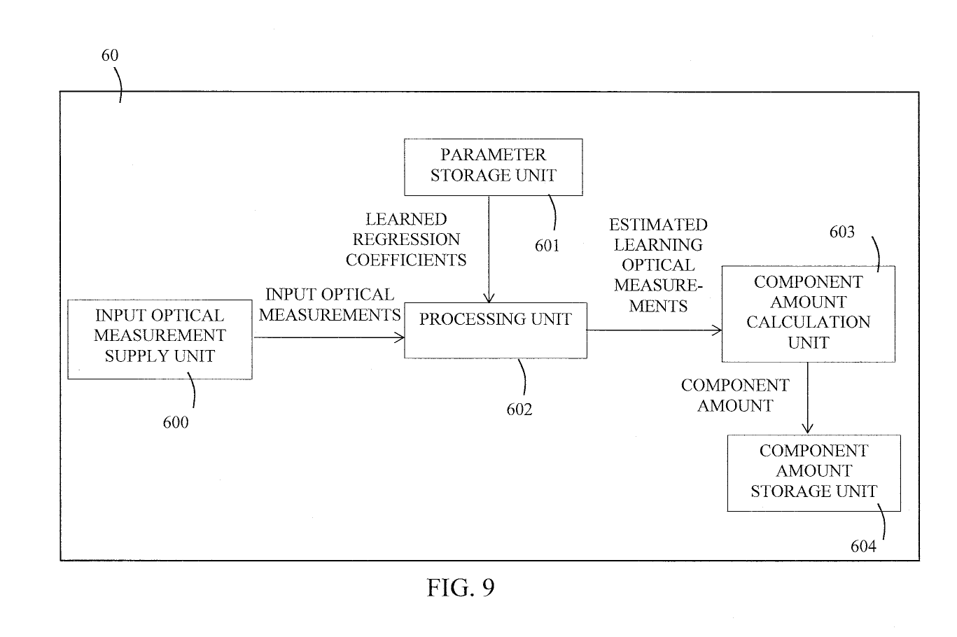

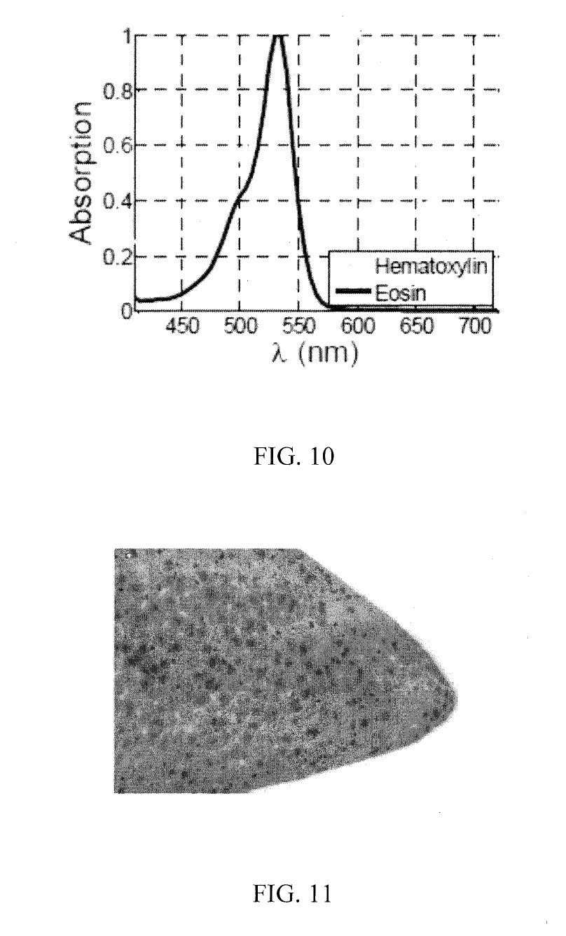

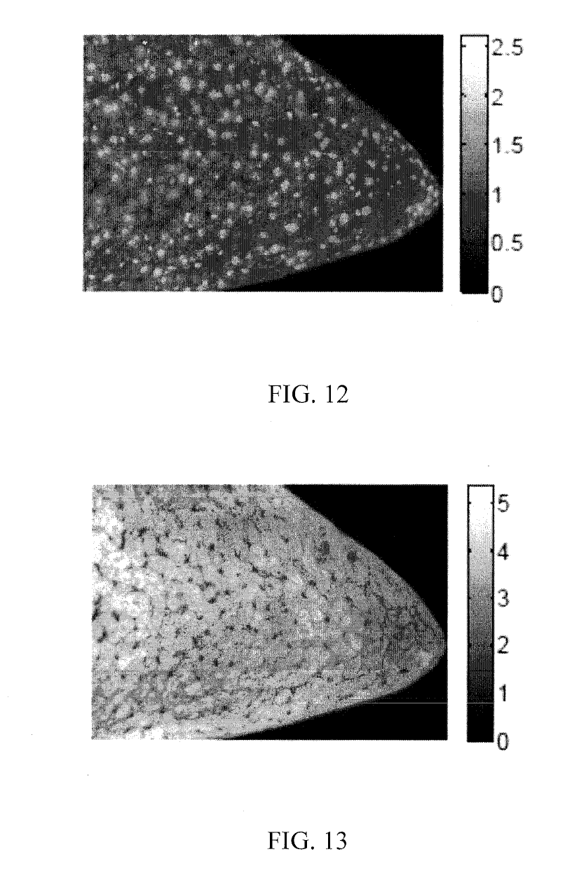

FIG. 9 is a schematic diagram showing a processing system 60 for calculating component amounts from estimated learning optical measurements of a mixture. Input optical measurement supply unit 600 supplies input optical measurements of a mixture for analysis of component amounts. Parameter storage unit 601 stores learned regression coefficients, which were found by the learning device 50 shown in FIG. 8. Processing unit 602 calculates estimated learning optical measurements for the mixture. The component amount calculation unit 603 calculates component amounts of mixtures from the estimated learning optical measurements. Component amount storage unit 604 stores the calculated component amount.

An embodiment detailed in FIGS. 8 and 9 leverages training data and learning to estimate learning optical measurements from input optical measurements. Since the input optical measurements and learning optical measurements are similar in nature, this estimation process may allow the use of more simple regression functions or allow more accurate estimation than directly estimating component amounts. The component amounts can readily be calculated from the estimated learning optical measurements by methods either generally known in the field or as prior art, as described in more detail above with reference to FIG. 1.

Furthermore, in some embodiments the learned regression coefficients are optimally found over input optical measurements and associated spectra, where the associated spectra are functions of wavelength (either continuous or many samples) that are the measured reflectance, absorption and/or transmittance of the mixture. Furthermore, these learned regression coefficients may then be used to calculate estimated spectra of a mixture, and then component amounts may be calculated from the estimated spectra.

One advantage of the devices and methods of some embodiments is that the regression function combined with learned regression coefficients offers fast computation of component amounts even though the initial learning procedure required to find the optimal parameters may require more computation. Once the learned regression coefficients are learned and stored, they can quickly be retrieved from memory and applied. For many estimation methods (including polynomial or log-polynomial functions), the computational complexity is directly proportional to the number of measurements required; this results in significant computational savings for methods of some embodiments which can be implemented with few measurements (roughly 3) compared to prior art methods that require many measurements (greater than 10).

Another advantage is that by optimizing over realistic training data, the best parameters for a specific application can be found. Generally the chosen regression function is an approximation that cannot perfectly calculate the component amounts for all possible mixtures. By choosing appropriate training data for a particular application, the best possible approximation for the regression function may be found. A method for choosing appropriate training data is to sample mixtures of actual interest when generating the training data. For example, if one is studying pathology slides, use actual pathology slides. If one is studying contaminants in water, use water mixtures that resemble the mixtures that will later be measured. (It would be counterproductive to train on water that contains an unrealistically large amount of contaminants because the approximation will generally be worse for realistic mixtures.) In other words, the user must specify which application and associated training set should be used. It may be possible to program the system to automatically determine which of the multiple training sets is most appropriate, but for most applications a viable alternative is to (1) have the user specify the training set or (2) the system is dedicated to applications with a specific set of training data. An example of (1) is to have the user specify they are analyzing a pathology slide with hematoxylin and eosin dyes as opposed to any other dyes, the system would then use an appropriate set of training data and associated learned regression coefficients.

In some embodiments it is desirable to consider the measurement noise when finding the optimal learned regression coefficients. By considering the measurement noise properties, the resultant learned regression coefficients can be more robust to measurement noise. When the signal and noise are assumed to be independent, the optimal learned regression coefficients that minimize the expected squared error given measurement noise are provided by a Wiener filter.

As an illustrative embodiment, the optimal learned regression coefficients were found using the procedure outlined in FIG. 2. The learning optical measurements were obtained from a microscope slide that was measured with narrowband optical measurement functions at every 5 nm between 410 nm and 720 nm, inclusive. The component amounts of hematoxylin and eosin dyes were calculated using Eq. (9). The input optical measurements are given by n=2 and found using optical measurement functions p₁(λ)=δ₅₅(λ−505), p₂(λ)=δ₅₅(λ−655). Let

$$g ( x ) = [ \begin{matrix}1 \\ log x \\ {( log x )}^{2}\end{matrix} ] \qquad ( 15 )$$

and the resultant regression function is a log polynomial of degree 2 given by the following equation:

\hat{d}=c₁+c₂ log y₁+c₃ log y₂+c₄(log y₁)²+c₅(log y₂)² (16)

where c₁, c₂, c₃, c₄, and c₅ are regression coefficients. In general a log polynomial is a polynomial function of the logarithms of a set of variables. Note that when optimal values for these regression coefficients are determined through learning, as described above, they are referred to as learned regression coefficients. Further note that the example of g(x) given in equation (15) above which generates a log polynomial regression function is suitable for mixtures that follow Beer-Lambert law.

Learned regression coefficients were found to estimate the eosin dye component amount from optical measurements of tissue samples stained with hematoxylin and eosin dyes mounted on microscope slides. For the microscope slide shown in FIG. 11, each pixel in the image was independently processed to estimate the eosin dye component amount using Eq. (16). The resultant mean squared error of the estimator is 0.0044. This is a 93% decrease in error compared to the result from the prior art given by Eq. (11).

An application for some embodiments is in the area of microscope analysis of dyed/stained tissue samples—an analytical tool frequently used in pathology. The slides are dyed with certain chemicals in order to make certain structures in the otherwise generally transparent tissue on the slide become more visible due to changed color or enhanced contrast. The resultant mixture of the dyes at various locations in the slide is optically measured. Typically three broadband measurements are taken that correspond to red, green, and blue wavelengths. Since the dyes are part of a mixture, it is difficult to determine the amount of each dye component at any location of the slide. For this application, the spectral absorption of the dyes and measurement functions of the microscope are readily known.

Some embodiments enable fast and accurate computation of the amount of dye component at each location in the pathology slide. Determining the amount of each dye at each pixel enables quantitative analysis and possible modification of the image. For example, knowledge of the amount of each dye enables rendering of virtual images of slides where the dye amounts have been adjusted to achieve a desired appearance. The amount of a particular dye can be increased or decreased and even eliminated to generate novel virtual images, which are difficult for a person to accurately visualize or for a computer to accurately simulate without the dye amounts. In addition, images may be processed using the dye amounts to achieve a standardized color appearance that accounts for any unwanted variation in the slide preparation, and thus may make certain poorly stained slides more useful for analytical purposes. (As described above, one advantage of the devices and methods of some embodiments is that the regression function combined with learned regression coefficients offers fast computation of component amounts even though the initial learning procedure required to find the optimal parameters may require more computation; this may result in significant computational savings for methods of some embodiments which can be implemented with few measurements (roughly 3) compared to prior art methods that require many measurements (greater than 10).)

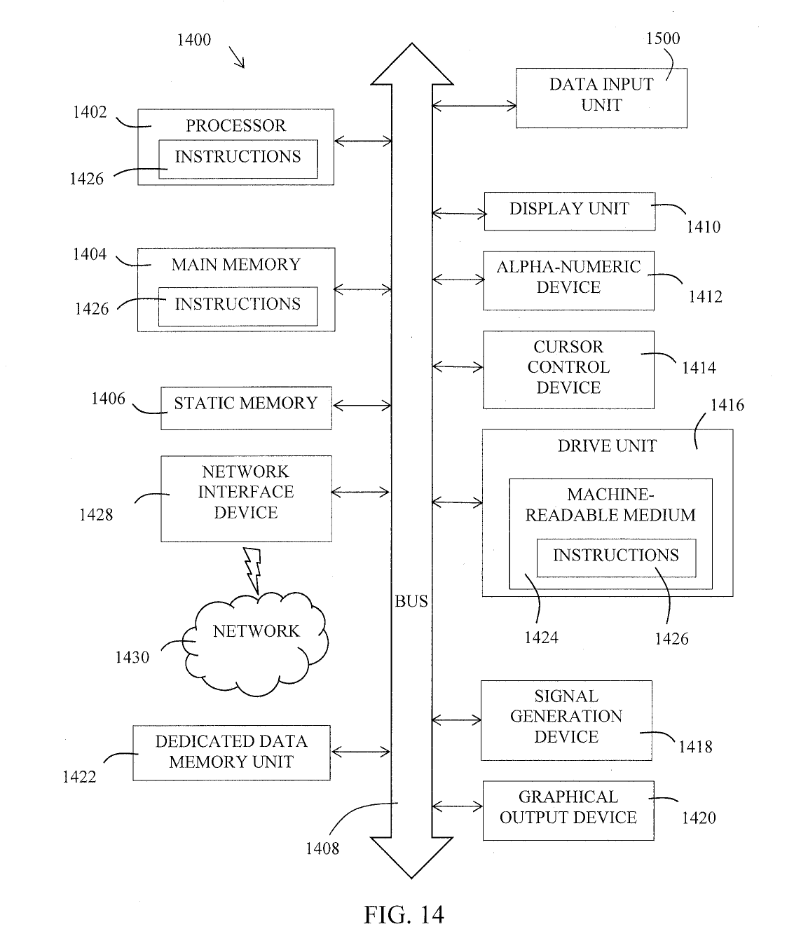

FIG. 14 is a block schematic diagram of a system in the exemplary form of a computer system 1400 within which a set of instructions for causing the system to perform any one of the foregoing methodologies and process flows may be executed. In alternative embodiments, the system may comprise a network router, a network switch, a network bridge, personal digital assistant (PDA), a cellular telephone, a Web appliance or any system capable of executing a sequence of instructions that specify actions to be taken by that system.

The computer system 1400 includes a processor 1402, a main memory 1404 and a static memory 1406, which communicate with each other via a bus 1408. The computer system 1400 may further include a display unit 1410, for example, a liquid crystal display (LCD) or a cathode ray tube (CRT). The computer system 1400 also includes an alphanumeric input device 1412, for example, a keyboard; a cursor control device 1414, for example, a mouse; a disk drive unit 1416, a signal generation device 1418, for example, a speaker, a graphical output device 1420, for example, a color printer, a dedicated data memory unit 1422, for example, a second disk drive unit, and a network interface device 1428.

The computer system 1400 may be connected to a data input unit 1500, for example optical measurement equipment, special optical measurement equipment and/or an image acquisition unit, via the bus 1408 as shown in FIG. 14, although the connection may also be through the network interface device 1428. Furthermore, data generated by one or more of the optical measurement equipment, special optical measurement equipment and image acquisition unit, may be provided to the computer system 1400 on a computer readable data storage device, such as read-only memory (ROM); random access memory (RAM); magnetic disk storage media; optical storage media; and flash memory devices. Furthermore, data generated by one or more of the optical measurement equipment, special optical measurement equipment and image acquisition unit, may be stored in the cloud, or another remote computer readable memory device and provided to the computer system 1400 through the network interface device 1428.

The disk drive unit 1416 includes a machine-readable medium 1424 on which is stored a set of executable instructions, i.e. software, 1426 embodying any one, or all, of the methodologies and process flows described herein. The software 1426 is also shown to reside, completely or at least partially, within the main memory 1404 and/or within the processor 1402. The software 1426 may further be transmitted or received over a network 1430 by means of the network interface device 1428.

The dedicated data memory unit 1422 is for storing one or more of learned regression coefficients, component amounts and component amount images. Memory unit 1422 may include any mechanism for storing information in a form readable by a machine, e.g. a computer, including read-only memory (ROM); random access memory (RAM); magnetic disk storage media; optical storage media; and flash memory devices. Furthermore, in embodiments data storage may be in the cloud—see below for further details.

In contrast to the system 1400 described above, other embodiments may use logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other forms of propagated signals, for example, carrier waves, infrared signals, digital signals, etc.; or any other type of media suitable for storing or transmitting information.

Further, it is to be understood that embodiments may include performing operations and using storage with cloud computing. For the purposes of discussion herein, cloud computing may mean executing software instructions on any network that is accessible by internet-enabled or network-enabled devices, servers, or clients and that do not require complex hardware configurations, e.g. requiring cables and complex software configurations. For example, embodiments may provide one or more cloud computing solutions that enable users to obtain compositional data, including images, etc. without user involvement on such internet-enabled or other network-enabled devices, servers, or clients. It further should be appreciated that one or more cloud computing embodiments may include using mobile devices, tablets, and the like.

Furthermore, it is to be understood that embodiments include learning devices and/or processing devices which may be integrated into and/or embodied within the computer systems dedicated to the aforementioned optical measurement equipment, special optical measurement equipment and/or image acquisition units; and that embodiments include performing operations and/or using storage on the aforesaid optical measurement equipment, special optical measurement equipment and/or image acquisition units.

Further, it is to be understood that embodiments include devices which are both learning devices and processing devices.

Furthermore, it is to be understood that imaging systems described herein may have one fixed light and a sensor with multiple channels, or alternate system arrangements. For example, in some embodiments an imaging system may be configured to acquire multiple images under different illumination conditions with a single channel sensor, and in other embodiments an imaging system may be configured to acquire multiple images with a single channel sensor by filtering light after passing through a sample. Furthermore, in embodiments a multiple channel sensor and multiple different illumination conditions may be used, such that a single image can be acquired from which an RGB image can be generated (or another image can be generated using different ones of the multiple channels). Yet furthermore, ambient illumination may be used without any lighting equipment. The spectral distribution of the energy of the illumination can be determined by measurement or may already be known.

Although embodiments of the present disclosure have been particularly described with reference to compositional analysis of mixtures using transmitted light, the teaching and principles herein are generally applicable to compositional analysis of mixtures using one or more of transmitted, reflected and scattered light from a sample of the mixture. For example, scattered light may be measured at one or more angles to the direction of the light incident on the sample; such measurements may be useful in the detection of the presence of certain components which are more visible at certain wavelengths and scattering angles. For example, Rayleigh scattering can detect the presence of particles smaller than the wavelength of light. Reflected light may be needed to measure mixtures that are opaque or are in close proximity to opaque objects. One example of the latter is animal or plant tissue that contains mixtures and exhibits subsurface scattering of light. A further example may be to measure the light reflected from human skin to determine the amount of various chemical compounds in the skin such as melanin, oxygenated hemoglobin, and deoxygenated hemoglobin.

Furthermore, the principles and teachings of the present disclosure may be applicable to the compositional analysis of mixtures by using fluorescence. In such an embodiment an appropriate excitation light would be needed to excite the component(s) of interest in the mixture. A filter may be used to remove the excitation light prior to the optical sensor. It may be possible to forego such a filter if the intensity of excitation and fluorescence lights can be estimated from the measurements, using the methods of embodiments described herein. (If it is correct to assume that the fluorescence intensity is approximately proportional to the amount(s) of fluorescent material(s), then the amounts of different fluorescent materials may readily be determined from mixtures of those materials using methods of embodiments described herein.)

Although embodiments of the present disclosure have been particularly described with reference to compositional analysis of mixtures of dyes in pathology slides, the teaching and principles herein are generally applicable to compositional analysis of mixtures in a wide range of samples including: liquids with contaminants, such as milk plus contaminant, and water plus contaminant; colored glass such as glass comprising brown, green and white glass components; gases containing particulates, such as air contaminated with particulate pollutants; and human skin from which reflected light may be analyzed to determine the amount of various chemical compounds in the skin such as melanin, oxygenated hemoglobin, and deoxygenated hemoglobin.

Although embodiments of the present disclosure have been particularly described with reference to certain embodiments thereof, it should be readily apparent to those of ordinary skill in the art that changes and modifications in the form and details may be made without departing from the spirit and scope of the disclosure. For example, embodiments using measurements in the visible spectrum including red/green/blue measurements have been described, but, it will be appreciated by those skilled in the art that depending on the mixtures being analyzed, other optical measurements may be used such as measurements using other parts of the electromagnetic spectrum—for example, infrared and ultraviolet.

What is claimed is:

1. A system for calculating regression coefficients for estimating amounts of components in a mixture of components, the system comprising:
an input optical measurement supply unit for supplying input optical measurements of a reference mixture,
a learning optical measurement supply unit for supplying learning optical measurements of the reference mixture,
a component amount calculation unit for calculating component amounts from the learning optical measurements,
a learning unit for obtaining the input optical measurements and the component amounts and calculating learned regression coefficients over the input optical measurements and the component amounts, and
a parameter storage unit for storing the learned regression coefficients,
wherein the learning optical measurements are characterized by one or more of (1) having more bands than those of the input measurements and (2) being narrowband measurements.

2. The system of claim 1, wherein the learning unit calculates the learned regression coefficients using least squares optimization.

3. The system of claim 1, wherein the learning unit calculates the learned regression coefficients using a Wiener filter.

4. A system for estimating component amounts from optical measurements of a mixture, the system comprising:
a first input optical measurement supply unit for supplying input optical measurements of the mixture;
a parameter storage unit for storing learned regression coefficients; and
a processing unit for obtaining the input optical measurements and the learned regression coefficients, applying a regression function using the learned regression coefficients to the input optical measurements, and estimating component amounts of the mixture.

5. The system of claim 4, further comprising:
a component amount storage unit for storing the component amounts.

6. The system of claim 4, wherein the learned regression coefficients were calculated by an apparatus comprising;
a second input optical measurement supply unit for supplying input optical measurements of a reference mixture,
a learning optical measurement supply unit for supplying learning optical measurements of the reference mixture,
a component amount calculation unit for calculating component amounts from the learning optical measurements, and
a learning unit for obtaining the input optical measurements and the component amounts and calculating learned regression coefficients over the input optical measurements and the component amounts.

7. The system of claim 6, wherein the regression function included a log polynomial function.

8. The system of claim 6, wherein the processing unit applied a color transformation to the input optical measurements prior to applying the regression function.

9. The system of claim 4, wherein the learned regression coefficients were calculated by a learning apparatus comprising:
a component amount storage unit for storing component amounts,
a mixture measurement unit for obtaining input optical measurements from mixtures with the component amounts,
a learning unit for obtaining the component amounts and the input optical measurements, and calculating learned regression coefficients over the component amounts and the input optical measurements.

10. The system of claim 4, wherein the first input optical measurement supply unit is an image acquisition unit, the input optical measurements include an input image, and the component amounts include a component amount image.

11. A system for calculating learned regression coefficients for estimating component amounts of a mixture, the system comprising:
a component amount storage unit for storing component amounts,
a mixture measurement unit for obtaining input optical measurements from mixtures with the component amounts,
a learning unit for obtaining the component amounts and the input optical measurements, and calculating learned regression coefficients over the component amounts and the input optical measurements, and
a parameter storage unit for storing the learned regression coefficients.

12. A system for estimating component amounts from optical measurements of a mixture, comprising:
an input optical measurement supply unit for supplying second input optical measurements of the mixture,
a parameter storage unit for storing learned regression coefficients,
wherein the learned regression coefficients are optimally found over first input optical measurements and associated learning optical measurements,
wherein the learning optical measurements are characterized by one or more of (1) having more bands than those of the input measurements and (2) being narrowband measurements,
a processing unit for obtaining second input optical measurements and the learned regression coefficients,
applying a regression function using the learned regression coefficients to the second input optical measurements, and
estimating learning optical measurements of the mixture,
a component amount calculation unit for calculating component amounts based on the estimated learning optical measurements, and
a component amount storage unit stores the component amounts.

13. The system of claim 12, wherein the processing unit applies a color transformation to the input optical measurements prior to applying the regression function.

14. A system for estimating component amounts of a mixture, comprising:
an input optical measurement supply unit for supplying second input optical measurements of the mixture,
a parameter storage unit for storing learned regression coefficients,
wherein the learned regression coefficients are optimally found over first input optical measurements and associated spectra,
a processing unit for obtaining the second input optical measurements and the learned regression coefficients,
applying a regression function using the learned regression coefficients to the second input optical measurements, and
calculating estimated spectra of the mixture,
a component amount calculation unit for calculating component amounts from the estimated spectra, and
a component amount storage unit for storing the component amounts.

15. A method of calculating learned regression coefficients for the estimation of mixture component amounts, the method comprising:
supplying input optical measurements of a reference mixture to a learning unit,
supplying learning optical measurements of the reference mixture to a calculation unit,
in the calculation unit, calculating component amounts from the learning optical measurements,
in the learning unit, calculating learned regression coefficients over the input optical measurements and the component amounts, and
storing the learned regression coefficients in a storage unit,
wherein the learning optical measurements are characterized by one or more of (1) having more bands than those of the input measurements and (2) being narrowband measurements.

16. The method of claim 15, wherein calculating learned regression coefficients includes calculating the learned regression coefficients using least squares optimization.

17. The method of claim 15, wherein calculating learned regression coefficients includes calculating the learned regression coefficients using a Wiener filter.

18. A method of estimating component amounts from optical measurements of a mixture, the method comprising:
supplying input optical measurements of the mixture to one or more processing units;
storing learned regression coefficients in a storage unit; and
in the one or more processing units, applying a regression function using the learned regression coefficients to the input optical measurements, and estimating component amounts of the mixture.

19. The method of claim 18, further comprising:
storing the component amounts in a storage unit.

20. The method of claim 18, further comprising calculating the learned regression coefficients by at least:
supplying input optical measurements of a reference mixture,
supplying learning optical measurements of the reference mixture,
calculating component amounts from the learning optical measurements, and
calculating learned regression coefficients over the input optical measurements and the component amounts.

21. The method of claim 20, wherein the regression function includes a log polynomial function.

22. The method of claim 20, further comprising:
applying a color transformation to the input optical measurements before applying the regression function.

23. The method of claim 18, further comprising calculating the learned regression coefficients by:
storing component amounts,
obtaining input optical measurements from mixtures with the component amounts, and
calculating learned regression coefficients over the component amounts and the input optical measurements.

24. The method of claim 18, wherein supplying input optical measurements of the mixture and the input optical measurements includes a component amount image.

25. A method of calculating learned regression coefficients for estimating component amounts of a mixture, the method comprising:
storing component amounts in a component amount storage unit,
in a mixture measurement unit, obtaining input optical measurements from mixtures with the component amounts,
in a learning unit, calculating learned regression coefficients over the component amounts and the input optical measurements, and
storing the learned regression coefficients in a parameter storage unit.

26. A method of estimating component amounts from optical measurements of a mixture, comprising:
optimally finding learned regression coefficients over first input optical measurements and associated learning optical measurements, wherein the learning optical measurements are characterized by one or more of (1) having more bands than those of the input measurements and (2) being narrowband measurements,
storing the learned regression coefficients in a parameter storage unit,
supplying second input optical measurements of the mixture to an input optical measurement supply unit,
in one or more processing units, applying a regression function using the learned regression coefficients to the second input optical measurements, estimating learning optical measurements of the mixture, and calculating component amounts based on the estimated learning optical measurements, and
storing the component amounts in a component amount storage unit.

27. The method of claim 26, further comprising:
applying a color transformation to the input optical measurements before applying the regression function.

28. A method of estimating component amounts of a mixture, comprising:
supplying second input optical measurements of the mixture,
storing learned regression coefficients a parameter storage unit for, wherein the learned regression coefficients are optimally found over first input optical measurements and associated spectra,
in one or more processing units, applying a regression function using the learned regression coefficients to the second input optical measurements, and calculating estimated spectra of the mixture,
in a component amount calculation unit, calculating component amounts from the estimated spectra, and
storing the component amounts in a component amount storage unit.
